(19) United States
(12) Patent Application Publication
(10) Pub. No.: US 2011/0126626 A1
(43) Pub. Date: Jun. 2, 2011

(54) Device and Method for the Non-Destructive Testing of Objects Using Ultrasound and the Use of Matrix-phased Array Probes

(76) Inventors: Roman Heinrich Koch, Bavaria (DE); Albrecht Maurer, Bavaria (DE); Walter Franz De Odorico, Bavaria (DE); Ioana Francisca Waedt, Bavaria (DE)

(21) Appl. No.: 12/994,595

(22) PCT Filed: May 28, 2009
(86) PCT No.: PCT/EP2009/056584

§ 371 Date: Feb. 11, 2011

(30) Foreign Application Priority Data
May 28, 2008 (DE) 10 2008 002 859.2

(51) Int. Cl. G01N 29/00

(52) U.S. Cl. 73/632

(57) ABSTRACT

The invention relates to a device (68) and a method for the non-destructive testing of planar objects (70) such as thick or thin metal sheets using ultrasound in different focal zones, said device comprising one or more independently controllable probes (PK1-PKn), and to the use of matrix phased array probes. To achieve uniform sensitivity over a wide thickness range, the probes (PK1-PKn) are designed as 2-dimensional phased array probes (PK2-PKn) and are located in rows offset in relation to one another. The sum of the number and length of the individual probes (PK1, PKn) corresponds to the width of the material to be tested.

The invention relates to a device and method for the non-destructive testing of planar objects such as thick or thin metal sheets using ultrasound in different focal zones, said device comprising one or more independently controllable probes, and to a use of matrix-phased array probes.

U.S. Pat. No. 7,263,888 describes a two-dimensional phased array for volumetric ultrasonic testing and a method for use of phased arrays. The phased array comprises a plurality of ultrasonic transducers arranged in a rectilinear pattern. The two-dimensional array enables electronic adjustment of focal properties and of the size of the aperture in both the azimuthal and elevational directions, so that uniform and/or specified sound field characteristics can be obtained at any or at all locations in the component being tested.

Modulation can be applied to each of the ultrasonic elements to form a scanning beam and to scan at least one area of the test material with the scanning beam.

The two-dimensional phased array offers when compared to a 1-dimensional linear array the advantage that it is separated and/or divided into a plurality of discrete ultrasonic transducers extending in both the X and Z directions. Consequently, the formation of a scanning beam can take place in both the X-Y plane and the Z-Y plane. This enables three-dimensional control of the scanning beam with respect to focal depth, steering angle, and focal geometry. Control of the aperture also contributes to the formation of the scanning beam. The aperture of the array can be selected by multiplexing the scanning beam to connect synchronous channels to individual transducers of the array. Also, the size of the aperture can be controlled and/or adjusted in both the X and Z directions.

DE-A-10 2004 059 856 describes a method for the non-destructive testing of a test body by means of ultrasound. In this method, ultrasound waves are injected into the test body with one or more ultrasound transducers, and ultrasound waves reflected inside the test body are received by a plurality of ultrasound transducers and converted into ultrasound signals. The ultrasound signals detected in individual measurement intervals are individually saved and are accessible for offline evaluation after termination of the measurement. By using corresponding reconstruction algorithms, it is thus possible to subsequently synthesize any acoustic irradiation angle and focusing in the physically possible volume range of the test body from the saved ultrasound signals without the need for additional ultrasound measurements. On the assumption that all transmitters transmit simultaneously, the number i of ultrasound transmitters and the specific composition of the transmitter group, in particular its arrangement on the test body surface, also determine the overall radiation characteristics (aperture) of the transmitter group and furthermore the sensitivity and the resolution of the measurements. The activation of all ultrasound transducers of an array for transmission of a complete wave front is not disclosed in this publication.

DE-C-34 42 751 relates to a test system operating with ultrasound for metal sheets of varying width conveyed lying flat on a roller conveyor. The facility comprises test heads (probes) adjustable towards the sheet and provided in a plurality of rows transversely to the conveying direction and arranged one behind the other with an overlap of their test tracks, and each having a transmitter and a receiver. Furthermore, a device is provided for applying a water film between each probe and the metal sheet. The probes within each row are arranged movably or adjustably transversely to the conveying direction for setting an equal spacing between the probes and for continuing the overlapping test tracks. Furthermore, a device for measuring the metal sheet width is provided. The probes of one row are set in accordance with the measured sheet width between the longitudinal edges of the metal sheet such that two probes of this row are adjusted towards the sheet adjacent to the edge.

U.S. Pat. No. 4,989,143 describes a method for representing a coherent energy beam and in particular a new method for improved adaptive formation of a coherent beam using iterative phase conjugation in order to counteract the effects of inhomogeneous wave propagation.

The article by SUNG-JIN SONK et al. “Development of an Ultrasonic Phased Array System For Nondestructive Tests of Nuclear Power Plant Components”, in “Nuclear Engineering and Design 214” (2002); p. 151-161, describes a phased array ultrasonic inspection system which arose from the modification of a medical ultrasound imaging system that had 64 individual transceiver channels. The document describes the time-lagged operation of ultrasound transmitting elements.

AT-B-307 088 describes a device for continuous strip testing comprising at least one test probe. A frame receiving the test probe and adjacent to the strip is suspended in a support oscillating about a horizontal axis extending in the strip running direction. The support is mounted in a base frame oscillating about a horizontal axis extending transversely to the strip running direction.

DE-U-72 40 684 describes a probe for systems for continuous ultrasonic testing of rolled strip. The probe comprises a probe housing and at least one ultrasonic probe arranged therein, where the probe housing is designed as a coupling chamber through which can flow a coupling liquid and is movably connected to a test carriage. A pre-wetting chamber is provided in front of the coupling chamber. Guide rollers are fitted underneath the probe housing and a wiper is provided behind the coupling chamber.

A method and a device for ultrasonic inspection of different zones of a billet are described in U.S. Pat. No. 5,533,401. Here a plurality of ultrasonic transducers with focal zones of varying depth is positioned for examining a cylindrical titanium billet through its thickness. The focal zones partially overlap the adjacent focus zones, thus ensuring complete examination through the thickness of the entire billet. The reflected signals from the transducer receivers are processed into digital form to generate an image of the billet.

A method of this type is however expensive, since every probe has to be individually adjusted and adaptation to surface irregularities is difficult.

A method for non-destructive inspection of a test body using ultrasound is described in DE-A-10 2005 051 781. In this method, ultrasonic waves are injected into the test body with one or with a plurality of ultrasonic transducers, and ultrasonic waves reflected inside the test body are received by a plurality of ultrasonic transducers and converted into ultrasonic signals. An ultrasonic transducer is provided on one surface of the test body and activated such that the ultrasonic waves coupled into the test body propagate largely uniformly spatially distributed inside the test body.

Then the ultrasonic waves reflected inside the test body are received with a plurality of ultrasonic transducers provided on the surface and ultrasonic time signals are generated containing time-resolved amplitude information.

The ultrasonic time signals are saved. Then a three-dimensional volumetric image, a sector image in the form of a two-dimensional ultrasonic sectional image through the test body or an A-image in the form of a one-dimensional time-resolved and locally resolved ultrasonic signal along a given irradiation angle is reconstructed, exclusively using at least a part of the ultrasonic time signals.

A further method is described in EP-B-1 649 301. With this method, a complete wavefront is transmitted to at least one section of the object to be tested using a plurality of independent transmission elements. A wave reflected from the surface of the object is then received by a plurality of independent receiver elements. The signals received by the receiver elements are then digitized in digitizing steps and further processed. Dynamic depth focusing or aperture adaptation is not touched upon in EP-B-1 649 301.

In the prior art, dual contact probes with water film coupling and plastic interface are used. Each of up to 100 probes must be individually positioned, requiring high expenditure on control technology. In addition, the probes must be routinely tested for suitable ultrasonic coupling quality.

Since each probe can only operate when it is completely covered by the sheet to be tested, sheet edges have a non-examined minimum zone which is as wide as the width of the individual probe. This width is currently in the region of 50 mm.

Proceeding from that basis, the object underlying the invention is to develop a device for testing of planar material such as thick or thin metal sheet such that a uniform sensitivity is achieved over a wide thickness range. Furthermore, the device should be improved to the extent that no moving parts are required and that it is suitable for testing the planar materials close to their edges without any additional equipment. A new and inventive used of a phased array is proposed.

To solve the problem, it is also provided that the probes are designed as two-dimensional phased array probes and are arranged in a row next to one another and without any gaps, the sum of the number and the length of the individual probes corresponding to a width of the material to be tested. The two-dimensional phased array probe or the probe strip formed by lining up probes without gaps is used to improve signal quality and resolution, employing dynamic depth focusing and dynamic aperture adaptation. The mechanical design of the probe and probe holder is simplified by an ultrasound coupling using segment immersion technology.

The use of matrix array probes individually programmable to specific thickness zones enables the poor resolution of conventional immersion technology probes to be overcome.

The segment immersion technology permits a much simpler mechanical solution when compared with the standard water gap technology and does not require any additional probes following the edges to permit examination close to the sheet edges.

Compared with the prior art, a considerable mechanical simplification and higher resolution of imperfections are achieved. In additional, the local segment immersion technology is less sensitive to irregularities on the surface of the material to be tested.

The method and the device are suitable for testing thin and thick metal sheets in the thickness range of 4 to 400 mm.

The pixelization over a sheet width is usually between 12 and 17 mm, whereas with the technology in accordance with the invention 4 to 8 mm can be achieved.

The probes are preferably arranged in a water pool which is adjustable relative to an underside of the material to be tested using control elements for the purpose of undulation adjustment. The water pool is in accordance with a preferred embodiment sealed by means of a preferably all-round sealing element such as a lip seal from the underside of the material to be tested. Furthermore, the water pool can have in the testing direction towards the underside of the material to be tested gliding elements such as runners to prevent any damage to the water pool due to excessive irregularities of the test material.

To further improve the signal energy and signal resolution for phased array applications for various imperfection depths during testing of planar materials, it is proposed in accordance with an idea inventive per se that during receiving a continuous change of time-lag values and/or the number of receiving elements takes place for each digitization step. This achieves an improvement in the sound energy and resolution for phased array applications for various defect depths “on the fly” with one receiving/one transmission cycle with a continuous focal law, i.e. change in time-lag values and number of transmitting/receiving elements or optionally by combination of various focal laws.

The continuous change in the time-lag values and/or number of transmitting/receiving elements for a virtual probe is made “on-the-fly” during receiving of the HF signal by a suitable firmware program.

Overall, a better performance and improved defect detection with reduced testing costs is achieved when compared with the prior art.

With the method in accordance with the invention, dynamic depth focusing (runtime-controlled focusing) and dynamic aperture adaptation (runtime-controlled receiving aperture) of the receiving part of a phased array application can be performed. The focal law or the time-lag values and the number of transmitting/receiving elements of the virtual probe are changed from one digitization step to the next.

In accordance with a preferred procedure, the time-lag values are calculated from a saved start time-lag (focal law for surface position) to an end time-lag (focal law for rear wall position) by means of a distance function 1/R where R=radius.

Optionally, the time-lag values can be saved in a reference table, in particular in the case of complex coherence.

A further procedure is characterized in that an aperture adaptation is achieved by a linear change in the start elements of the virtual probe relative to the number of end elements.

The start of the aperture change can be triggered with the “time-of-flight” position of the surface/interface echo.

A further procedural step is characterized in that the summation of various focused transmitter shots into one signal is achieved by using a digital TGC function. It is provided here that the sensitivity differences occurring at the zone transition during the combination of transmitter shots focused at different depths into one signal are equalized by the use of a digital TGC function.

In accordance with an independent inventive idea, the invention furthermore relates to a method and device for definition of time-lags for phased array probes by functional dependences, for example by means of a Bezier function, a polynomial or another type of function. The function adopts the indices of the ultrasound transducer element as an argument and produces the time-lag as the result, while the parameters are set depending on the application.

The problem with the prior art is that the number of applicable time-lag sets for the arrays is in the final analysis limited by the capacity of the hardware and by the processing times for data transfer. With a larger number of elements and additional zones to be tested, the need for storage capacity increases.

In addition, the zone requires for varying time-lag laws a special treatment so that no discontinuity occurs within the images produced by the ultrasonic device. To overcome this, modern instruments compute the time-lag on the basis of a distance algorithm for very small zones or for every scanned point. This distance algorithm is only suitable for sufficiently homogeneous media without severe discontinuities, which are usual in non-destructive testing. When computing the distance, fixed relationships were already used, however with a significantly higher number of parameters being needed.

In accordance with the idea inventive per se as described here, this problem is solved by the use of functional descriptions for the time-lag-generating circuits. The time-lags generally used for ultrasonic problems can be defined by a static and differential function between the first element of the array and the last element of the array. The functional descriptions permit the generation of a curve for the time-lags of all elements, the time-lag value being a function of the array number. For one-dimensional arrays, this is a function with one variable, for 2-dimensional arrays it is a function of at least two variables and so on.

The functional description furthermore contains a limited number of parameters. These parameters change for each of the selected time-lag zones and must be individually adapted.

A one-dimensional virtual probe with 32 transmitter/receiver elements requires for example 64 time-lag values for a second zone. If a functional description in the form of a cubic Bezier function is applied, the number of required parameters for a second zone can be reduced to eight values: four values for transmission and four for receiving.

To smooth the transition between the time-lag zones, linear interpolations can be made between the functionally described values of two zones depending on the time difference between the currently considered scanning and two reference time positions. The same method can be used for apodization or overlap weighting. In this case the result of the functional description is the amplitude for the element of the array. The argument is the element itself, and the parameters are transmitted within the ultrasonic system or computed in advance for higher-dimensional cases and set down in a table to be transferred.

Thanks to the solution in accordance with the invention, the advantages obtained in comparison with the prior art are that considerably fewer parameters have to be transferred, so that less storage capacity is needed. The number of cycles too can be increased, and an adaptation to highly complex geometrical situations is likewise possible.

In summary, the method in accordance with the invention is characterized in that parametrizable functions are used for the time-lag zones instead of fixed formulas or time-lag sets.

Further details, advantages and features of the invention can be gathered not only from the claims and in the features to be found therein, singly and/or in combination, but also from the description of preferred embodiments to be found in the description of the drawing.

The drawing shows in:

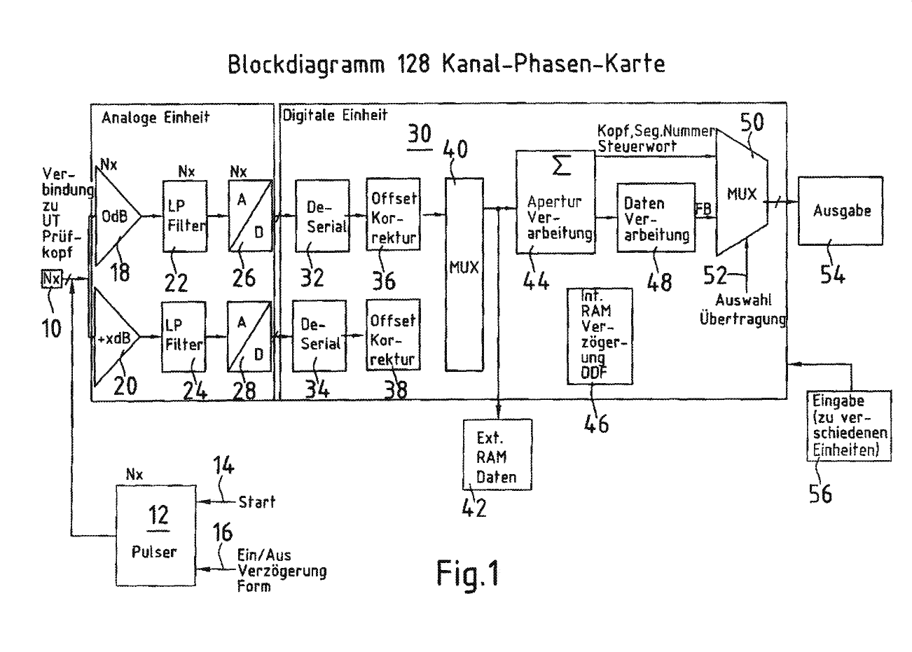

FIG. 1 a block diagram of a control unit for phased array probes,

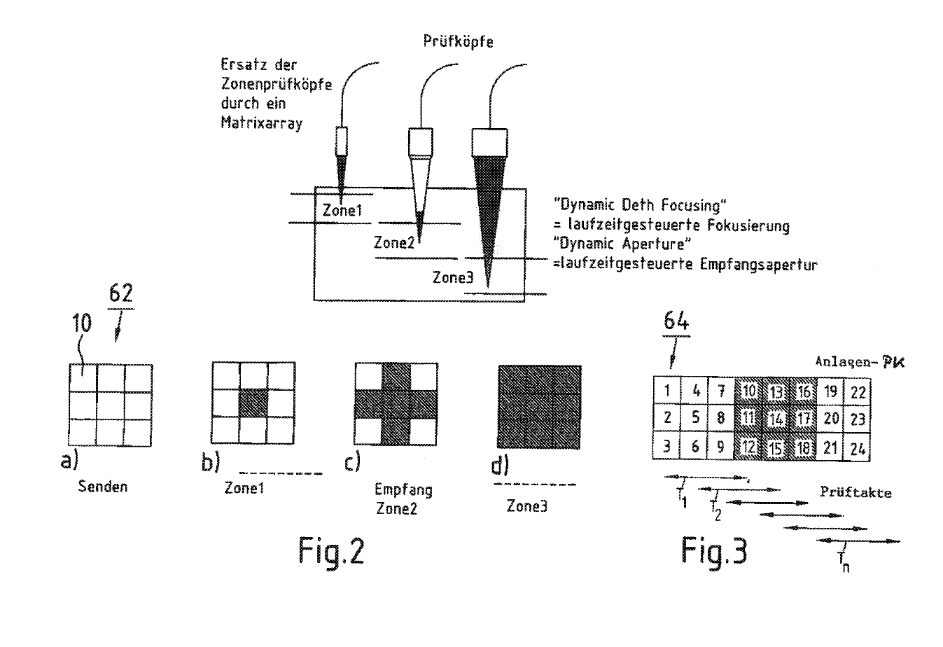

FIGS. 2a)-d) a schematic representation of a plan view onto a probe in the transmitting and receiving state,

FIG. 3 a schematic representation of a probe with different system testing cycles,

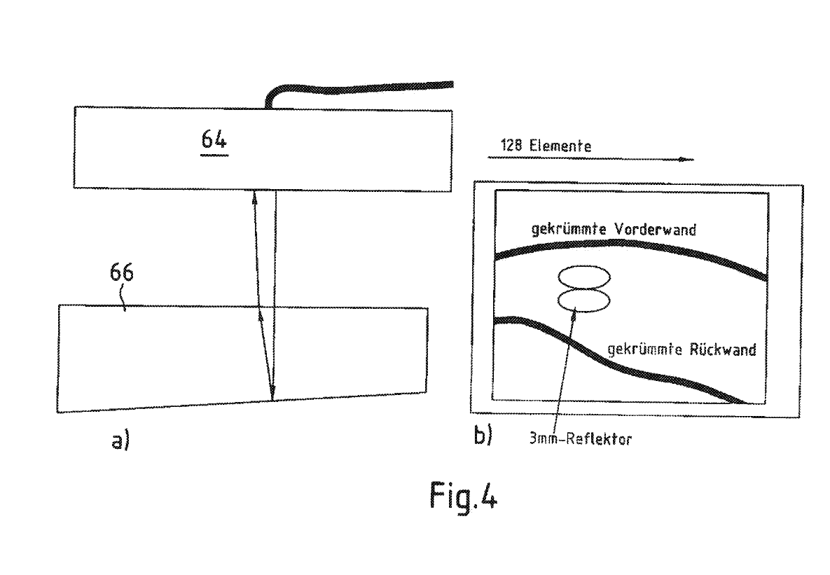

FIGS. 4a), b) a schematic representation of a probe above a non-ideal irradiation geometry and an image of a parallel B-scan,

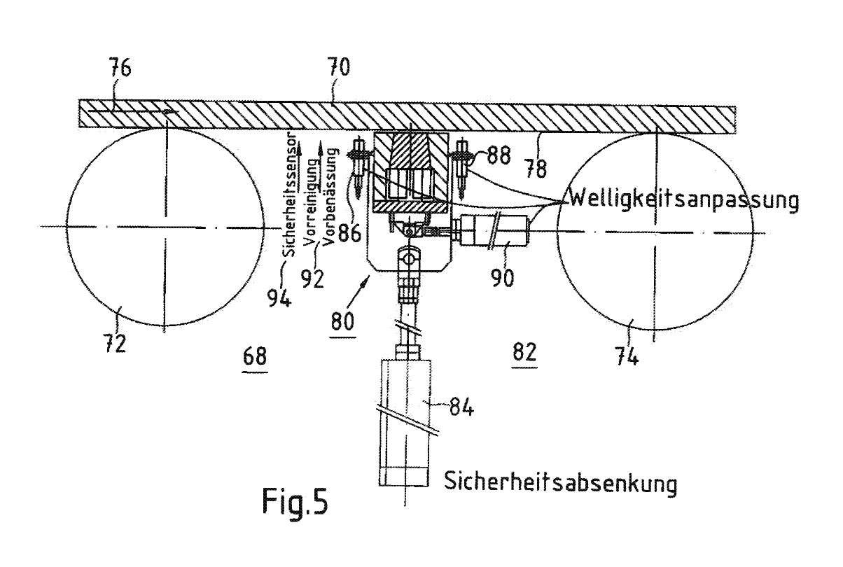

FIG. 5 a schematic representation of a probe arrangement in local immersion for testing a planar material from below,

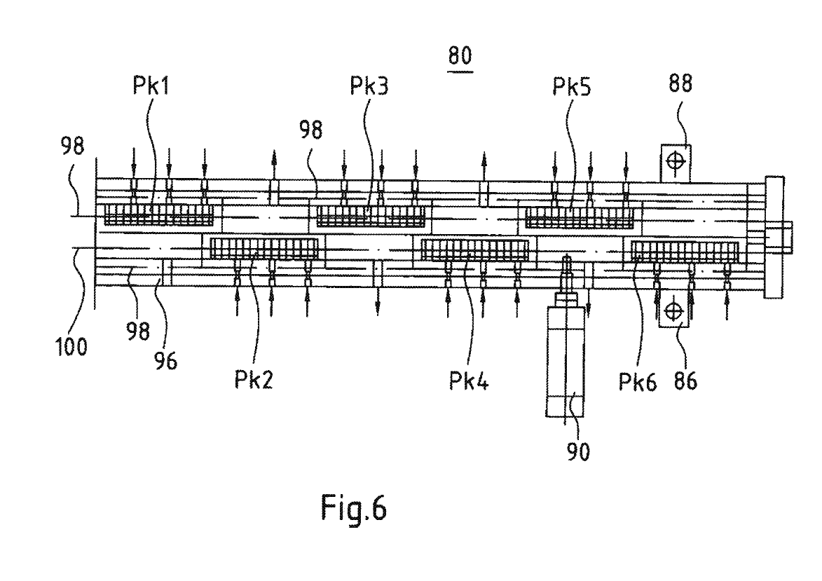

FIG. 6 a plan view onto the probe array in accordance with FIG. 5,

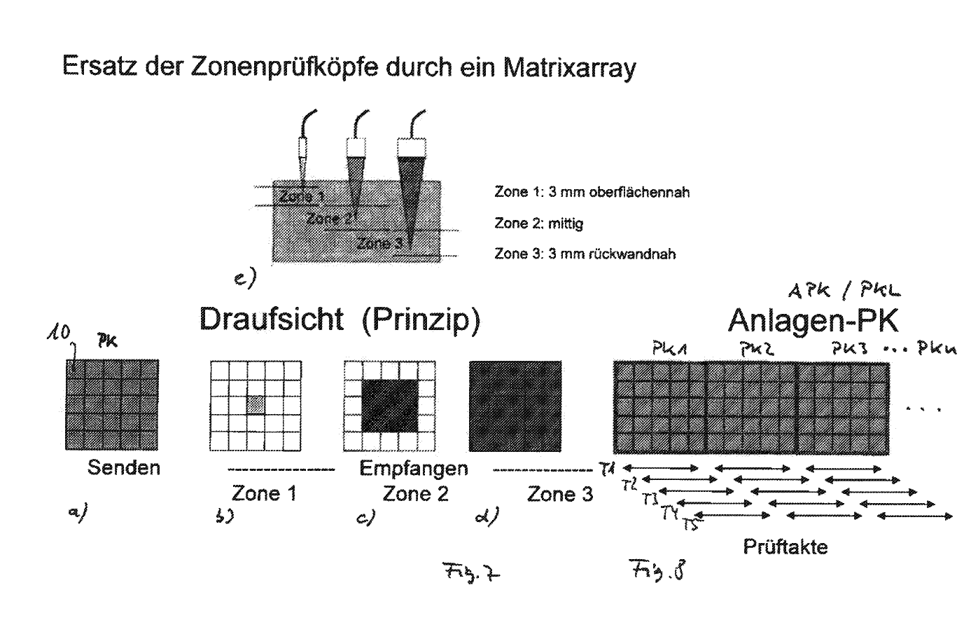

FIGS. 7a)-e) a schematic representation of a plan view onto a probe in the transmitting and receiving state,

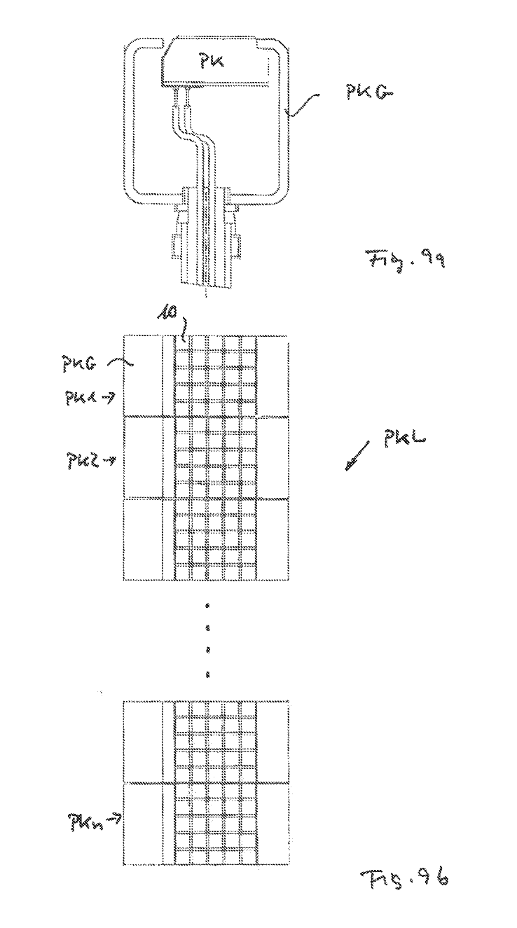

FIG. 8 a schematic representation of a probe with different testing cycles,

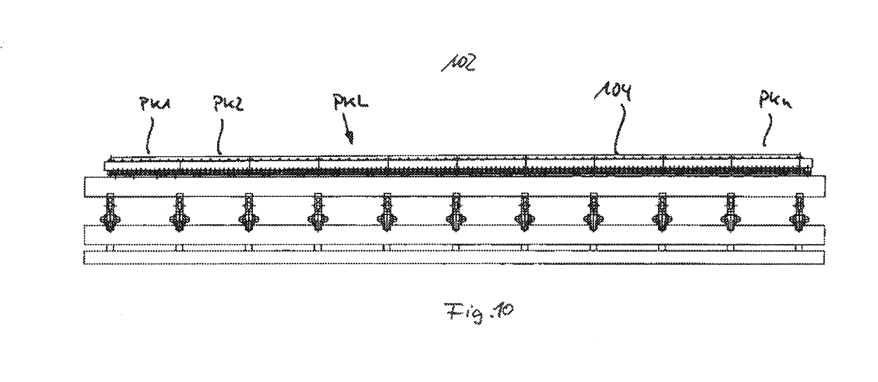

FIGS. 9a), b) a side view of a probe strip and a plan view onto a probe strip,

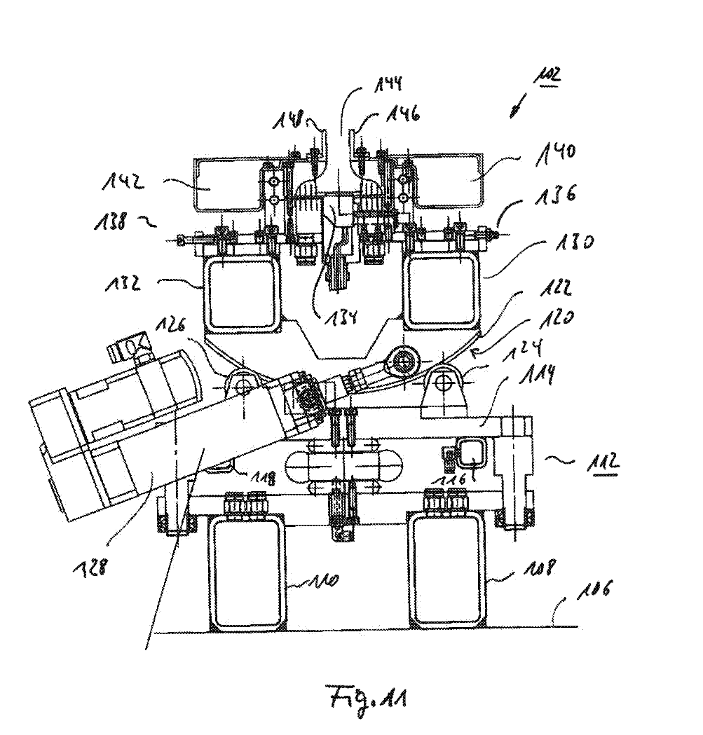

FIG. 10 a front view of a second embodiment of a probe array in the form of a probe bar,

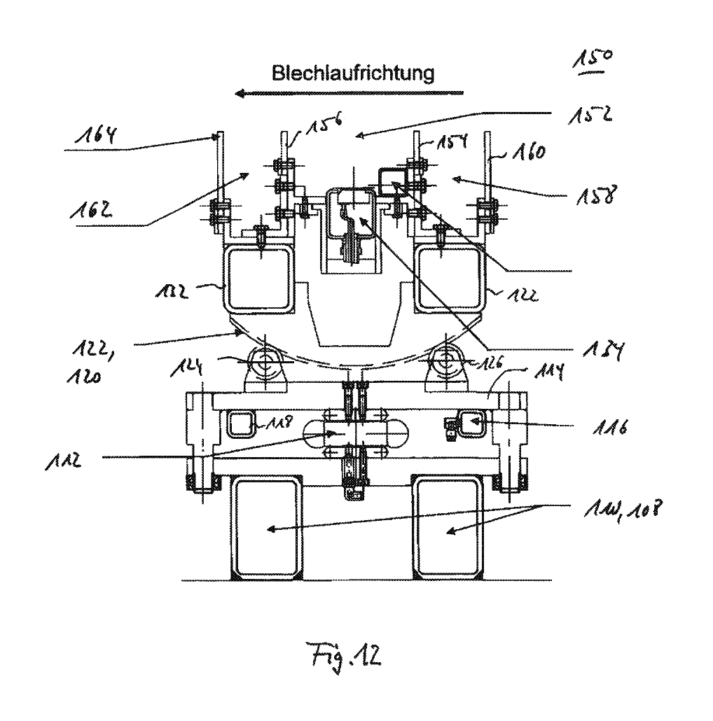

FIG. 11 a side view of the probe bar in accordance with FIG. 7 and

FIG. 12 a side view of a further embodiment of a probe bar.

FIG. 1 shows a block diagram of a control unit preferably comprising N=128 channels. For each of the up to N=128 ultrasonic transducer elements 10, a pulser 12 is provided which is controllable via an input 14. A time-lag of for example 5 ns can be switched on or off using a further input 16. The signals received from the ultrasonic transducer elements 10 are recorded in two channels, where each channel comprises an operational amplifier 18, 20, a low-pass filter 22, 24 and an AID converter 26, 28. The operational amplifiers 18, 20 of the individual channels have different amplifications. The A/D converters are connected to their digital output, i.e. to a programmable integrated circuit 30. The digital output of the A/D converter 26, 28 is connected to an input of a deserial module 32, 34. One output of the deserial module is connected to an input of an offset correction module 36, 38 whose outputs are connected to a multiplexer 40. The multiplexer 40 is connected on the output side to an external memory module 42 such as a RAM and to a processing unit 44.

In the processing unit 44, channel selection and also dynamic depth focusing and dynamic aperture adaptation take place. The time-lag provided is for example 5 ns. One output of the external memory module 42 is connected to the aperture processing unit 44. Furthermore, an internal memory module 46 is provided which is likewise connected to the aperture processing unit 44.

One output of the unit 44 having a summation module is connected to a processor 48 in which the amplification, filtering and time control amplification of real-time HF amplitude scaling is performed in a digital manner. At the output of the processor 48, a signal is transmitted which is applied at a first input 52.1 of a multiplexer 50. A header, a sequence number or a control word can be applied at a second input 52.2 of the multiplexer. The respective input can be selected using the third input 52.3. At the output of the multiplexer 50, for example, a 17 bit signal is applied which is made available for further processing via a fast serial link 54. A further component of the circuit is an input module 56 for entering signals at various units of the circuit 30.

The method in accordance with the invention is performed as follows. First, a complete wave front is transmitted via the pulse generators 12 by simultaneous (phase-rigid) control of all ultrasonic transducer elements vertically onto at least one section to be tested of an object. A wave reflected by the structure of the object is then received by a plurality of independent ultrasonic transducer elements 10. The signals received from the ultrasonic transducer elements 10 are digitized in a digital signal processing unit 30 in digitizing steps, electronically processed and saved in the memory module 44 or 46.

There is a continuous change here in time-lag values and/or in the number of ultrasonic transducer elements of a virtual probe for each digitization step on-the-fly, since for every digitization step on-the-fly the time-lag values and/or the number of ultrasonic transducer elements has to be adapted. The time-lag values are computed from a saved start time-lag (focal law for surface position) to an end time-lag (focal law for a rear wall position) by means of a distance function such as 1/R where R=radius. The time-lag values can be saved in a reference table, in particular in the case of complex coherence. In the present case, the time-lag values are plotted in the form of a curve.

The aperture adaptation is performed by linear change of the number of receiving elements, preferably in the summation module 44.

A major change in the time-lag values and/or aperture adaptation is usually triggered by the “time-of-flight” position (runtime position) of the surface/interface echo. In the summation module 44, summation is conducted of various focused transmitter shots into one signal by the use of a digital TGC function. Additionally, the time-lag values can be defined by functional dependences by means of, for example, a Bezier function, polynomial or other type of function, where the function indices of the ultrasonic transducer elements are used as the argument and the time-lag values are produced as the results, while parameters are set depending on the application.

FIGS. 2a to 2d show in purely schematic form plan views of a probe 62 in the form of a matrix-phased array probe. The latter comprises a plurality of individual ultrasonic transducer elements 10 which are individually controllable.

As already set forth, all ultrasonic transducer elements 10 are operated simultaneously for transmission, as shown in FIG. 2a.

Following the principle of runtime-controlled focusing (dynamic depth focusing) and runtime-controlled receiving aperture (dynamic aperture), for focus zones of interest in FIGS. 2b to 2d one element as in FIG. 2b, five elements as in FIG. 2c or nine elements as in FIG. 2d are switched to receive for focusing zones of differing depths.

Each probe 62 can for example have 128 ultrasonic transducer elements 10. Probes with 5×25=125 elements are preferably used, as a result of which an active surface can be obtained for example in the region of 35 mm×175 mm.

To cover metal sheet widths in the range from 1000 mm to 5300 mm, about 36 probes 62 are required.

A system probe 64 with 24 elements is shown in FIG. 3, where to match the system test cycle T1 . . . Tn nine ultrasonic transducer elements 10 are switched on in each case step by step and switched to receive.

With the method in accordance with the invention, a higher coupling reliability is obtained for rough surfaces compared with the conventional contact technology. Furthermore, all probes can be arranged without gaps over the entire sheet width, with a width pixelization of for example 6 mm. Edge and top/bottom testing are integrated into the concept. Also, higher-value reconstruction methods can be incorporated by early digitization of all test data. Furthermore, the parallel-B scan principle is made possible, i.e. transmitting and receiving of all ultrasonic transducer elements simultaneously.

The parallel-B scan method permits robust testing also for non-ideal irradiation geometries 66, as shown in FIG. 4a. The non-ideal irradiation geometry 66 can for example have a curved front wall and/or a curved rear wall, as shown in FIG. 4b.

A first embodiment of a test array 68 is shown in FIG. 5 in a side view. An object 70 to be tested in the form of a planar material such as a thin or thick metal sheet is mounted on transport rollers 72, 74 and is transportable in the direction of the arrow 76. On an underside 78 of the material 70 to be tested, a probe array 80 is provided by which the individual probes PK1-PKn are coupled by a segment technology to the material 70 to be tested. The probe array 80 is designed as a water chamber open to the top which equalizes via a continuous water supply the water loss incurred in the gap to the object 70 to be tested, and hence ensures a flawless coupling of the ultrasound. The probe array 80 is preferably sealed with a lip seal from the underside 78 of the material to be tested in order to reduce the water loss.

Alternatively, leading and trailing gliding shoes can be provided in the movement direction 76 of the test material 70 to protect the probe array 80 from damage when the test material is excessively uneven. The probe array 80 can be lowered using a control element 84 and dynamically readjusted using further control elements 86, 88, 90 for adapting the undulation. Mounted in front of the probe array 80 are a pre-cleaning unit or pre-wetting unit 92 and a safety sensor 94 ensuring shutdown in the event of a fault.

FIG. 6 shows a plan view of the probe array 80, where individual probes PK1-PK6 or PKn are arranged inside a water pool 96. The water pool is sealed by means of a preferably all-round sealing element 98 such as a lip seal from the underside 78 of the material 70 to be tested. Here the probes PK1, PK3, PK5 are arranged along a first longitudinal axis 98 at a distance from one another, where along a second axis 100 running parallel to the first axis the probes PK2, PK4, PK6 are arranged such that they run offset to the probes PK1, PK3, PK5. In this way, a total width B of the area to be tested is covered by ultrasonic transducer elements. Every single one of the ultrasonic probes Pk i is connected here to one of the ultrasonic control units i (in accordance with FIG. 1). In this way, the test can be conducted simultaneously and parallel with every single probe and hence the testing capacity can be increased. Inside a probe, focused transmission takes place depending on test requirements with a group of preferably 5×5 elements of the matrix probe onto the rear wall of the test specimen. The identical receiving group is then evaluated, depending on the depth zone, with the described dynamic aperture adaptation by selecting the appropriate receiving elements and/or dynamic depth focusing by the adaptation of the time-lags. To cover the entire probe surface, the described group in the next ultrasonic shot is then moved one matrix element further in the probe longitudinal direction until the entire probe aperture has been scanned. Alternatively, it is also possible in a further test mode to control the transmission-side aperture (e.g. only the middle element or a 3×3 element group) with appropriate focusing and to evaluate the saved and received ultrasonic signal from the various transmission shots combined corresponding to the depth zone again with aperture and focusing adaptation. A further test mode comprises a transmission shot of the entire aperture of the probe (e.g. 5×25 matrix elements) with linear focusing onto the rear wall of the test specimen and with evaluation of the saved reception signals in accordance with the method described at the outset of indexing a 5×5 element group.

The probe array 80 is able to perform a 100% surface test of untrimmed rolled plates in the production flow. It is possible here to treat/test metal sheets with lengths up to 30000 mm, widths of 1000 to 5300 mm and thicknesses in the range from 4 mm to 300 mm.

The test can be done in one pass, in particular surface zone and edge zone testing, where the latter can be done longitudinally and transversely. The test speed is about 0.5 m/sec for 1000 ultrasonic shots/sec. The coupling is done—as set forth above—via water gaps with a circulating water supply.

The method in accordance with the invention permits reliable detection depending on the material thickness, where with a thickness of 8 mm to 240 mm ERG Ø 3 can be reliably detected up to a distance of 3 mm from the surfaces, and in a thickness range of 240 mm to 400 mm ERG Ø 5 up to a distance of 5 mm from the surfaces.

Overall, a modular structure is aimed at for increasing functional reliability, availability and maintenance-friendliness.

The method can be verified for example under the following conditions. Test method: pulse echo method with a water distance of 80 mm

### TEST BODY 1

Material: carbon steel
Dimensions: length=200 mm, width=100 mm, thickness: 280 mm
Test defects: flat saddle holes, diameter 3 or 5 mm

### 28 May 2009-49271 B

### TEST BODY 2

Material: carbon steel
Dimensions: length=100 mm, width=100 mm, thickness: 20 mm
Test defects: blind holes, diameter 3 or 5 mm
Transducer (probe 1):
Type: 2D-face array transducer (18 elements)

### Frequency: 4 MHz

Element size: 7×7 mm²
Transducer (probe 2):
Type: 2D-face array transducer (24 elements)

### Frequency: 5 MHz

Element size: 6×6 mm²

The diagram of the matrix probe corresponds to that shown in FIG. 3.

A further diagram of a matrix probe is shown in FIG. 7. In accordance with FIG. 7a, the probe PK comprises 5×5=25 individual transmitting/receiving elements 10. The principle of runtime-controlled focusing (dynamic depth focusing) or runtime-controlled receiving aperture (dynamic aperture) can be seen in FIGS. 7b) to 7d). Corresponding to the evaluation of the number of received ultrasonic signals of a probe PK, various zones (zone 1, zone 2, zone 3) of a test object can be tested, as shown purely schematically in FIG. 7e).

FIG. 8 shows as an example lining up without gaps of individual probes PK1 . . . PKn to form a system probe APK or a probe strip PKL, which in turn results from lining up without gaps of system probes APK.

After transmission of the wave front by all probes PK1 . . . PKn, all ultrasonic receivers 10 of the probes PK1 . . . PKn are switched to receive, so that the incoming ultrasonic signals can be digitized in digitization steps and saved. Due to the timing of digitization, where the signals are digitized at any time, the signals receive depth information that can be evaluated. In a first test cycle T1, the 25 individual signals of each probe PK1 . . . PKn are evaluated “on-the-fly”, i.e. while the signals are still being received. In the further test cycles T2 . . . T5, already saved ultrasonic signals are evaluated by further cycling in a “virtual probe”, taking into consideration a continuous change in the time-lag values and/or in the number of receiving elements for each digitization step. Due to the digitization of the signals received by the receiving elements in digitization steps, every saved value also obtains depth information which can be evaluated. In the embodiment shown with probes PK with 25 transmitting/receiving elements, an evaluation can thus be made within 5 test cycles.

A single probe PK1 . . . PKn here comprises for example 5×5=25 individual transmitting/receiving elements 10 each with dimensions for example of 6×6 mm. The dimensions for a probe housing PKG shown in FIG. 9a are thus in the region of about 35 mm×34.8 mm with 25 transmitting/receiving elements. A probe strip PKL is shown in FIG. 9b.

With a sheet width of, for example max. 5350 mm and an assumed probe housing width with 25 transmitting/receiving elements of 35 mm, the result is a required number of probes for covering the sheet width of 5350/35=153.

Assuming that 125 channels are available for each control unit SE, the result is a probe number of 5 per electronic unit. For a required probe number of 153, 31 electronic units are necessary.

Using 31 electronic units which can each process 5 probes, the result is a maximum probe number of 155, hence permitting coverage of a width of 155×35 mm=5425 mm. This corresponds to an overlap of 75 mm in the case of a sheet width of 5350 mm.

FIG. 10 shows a front view of a second embodiment of a probe array 102 in the form of a probe bar. With this array, the probes PK1 . . . PKn in accordance with FIG. 9 are lined up without gaps as a probe strip PKL in order to permit complete testing of a planar material such as a metal sheet 104.

A side view of a first embodiment of the probe bar 102 is shown in FIG. 11. The probe bar 102 is arranged on a stationary or mobile support 106 not shown in further detail. Beams 108, 110 designed as a water supply are provided on this support. The beams 108, 110 are provided with a lifting device 112 using which the probe bar 102 can be advanced to the sheet 104 being tested. The lifting device can be of pneumatic design and have a stroke of around 20 mm in the extended state. The lifting device 112 comprises a height-adjustable platform 114 underneath which are arranged channels 116, 118 for the air supply.

In a preferred embodiment, the probe bar 102 is designed with an angle adjustment device 120 comprising an arc-shaped trough 122, swivellably mounted on rollers 124, 126 and settable using an adjusting mechanism 128. The angle can be set in the range from +/−5°.

The trough is provided with longitudinally running beams 130, 132 by which the probe strip 134 is dependably supported. For the alignment of the probe strip 134, in particular during initial assembly, adjusting elements 136, 138 are provided which rest on an upper side of the beams 130, 132. At the side of the probe strip 134, collecting channels 140, 142 are arranged for coupling water which flows off or is wiped off. Above the probe strip, a slot 144 for water coupling to the material for testing is provided and limited at the side by rubber facings 146, 158 contacting an underside of the material to be tested.

FIG. 12 shows a further embodiment of a probe bar 150 in a side view substantially corresponding to the embodiment according to FIG. 11, so that identical elements are identified with the same reference numbers.

In this embodiment, the probe strip 134 opens into a test trough 152 limited at the side by wiping and sealing lips 154, 156. Parallel to the test trough, a pre-wetting channel 158 is provided opposite the sheet running direction and is used to pre-wet the material to be tested. The channel is limited at the side by a wiping and sealing lip 160 and by the wiping and sealing lip 154.

In the sheet running direction, a collecting channel 162 receiving the water exiting from the test trough 152 runs parallel to the latter. The collecting channel is limited at the side by a wiping and sealing lip 164 and by the wiping and sealing lip 156.

1. A device (68) for the non-destructive testing of planar objects (70) such as thick or thin metal sheets using ultrasound in different focal zones, said device comprising one or more independently controllable probes (PK1-PK6), wherein the probes (PK1-PKn) are two-dimensional phased array probes (PK2-PKn) and are arranged in a row next to one another and without any gaps, the sum of the number and the length of the individual probes (PK1, PKn) corresponding to a width of the material to be tested.

2. The device according to claim 1, wherein the probes (PK1-PKn) are arranged in a water pool (96) which is adjustable relative to an underside (78) of the material (70) to be tested using control elements (86, 88, 90) for the purpose of undulation adjustment.

3. The device according to claim 1, wherein the water pool (96) is sealed by an all-round sealing element such as lip seals from the underside (78) of the material (70) to be tested.

4. The device according to claim 1, wherein the water pool (96) is provided with gliding elements in the testing direction towards the underside (78) of the material (70) to be tested in order to prevent any damage to the water pool due to excessive irregularities of the test material.

5. The device according to claim 1, wherein the probes (PK1-PKn) cover a width in the range of 1000 mm≦B≦5300 mm.

6. The device according to claim 1, wherein the probes (PK1-PKn) have an active surface in the range of 30 mm×150 mm.

7. The device according to claim 1, wherein the probes (PK1-PKn) have ultrasonic transducer elements (10) preferably with an area of 6×6 mm2 or 7×7 mm2, said ultrasonic transducer elements (10) being arranged at a distance in the range from 0.2 mm to 3 mm from one another.

8. The device according to claim 1, wherein the probes (PK1-PKn) are programmable to individual focal zones.

9. The device according to claim 1, wherein the probes (PK1-PKn) can be coupled by a segment immersion technology to the material (70) to be tested.

10. A method for non-destructive testing of objects (70) with a two-dimensional phased array probe (PK1-PKn) comprising testing a planar material employing dynamic depth focusing and dynamic aperture adaptation with at least one two-dimensional phased array probe (PK1-PKn).

11. Method for controlling one or more probes (PK1-PKn) for the non-destructive testing of objects (70) such as thick or thin metal sheets using ultrasound in different focal zones, the method comprising:
transmitting a complete wave front to at least one section of the object to be tested using a plurality of independent transmission elements,
receiving a wave reflected by the structure of the object by a plurality of independent receiving elements,
digitization of signals received by the receiving elements in digitization steps,
continuously changing one of time-lag values and the number of receiving elements for each digitization step.

12. Method according to claim 11, wherein the time-lag values are computed from a saved start time-lag using a focal law for the surface position to an end time-lag using a focal law for the rear wall position by means of a distance function.

13. Method according to claim 11,
wherein the time-lag values are saved in a reference table.

14. The method according claim 11, wherein an aperture adaptation is achieved by linearly changing the number of receiving elements.

15. The method according claim 11, wherein a start of the change in one of the time-lag value and aperture adaptation can be triggered by the “time-of-flight” position of one of a surface echo and an interface echo.

16. The method according claim 11, wherein summing various focused transmitter shots into one signal is done with a digital TGC function.

17. The method according claim 11, wherein time-lag values are defined by functional dependences such as a Bezier function, polynomial or other type of function, where the function element indices are used as the argument and the time-lag values are produced as the results, while parameters are set depending on the application.

18. The method according claim 11, wherein time-lag values are generated by linear combination of one or more instances of a method or by linear combination of difference instances of several of the stated methods.

19. (canceled)
